(19) United States
(12) Patent Application Publication
(10) Pub. No.: US 2014/0071720 A1
(43) Pub. Date: Mar. 13, 2014

(54) VOLTAGE CONVERTER AND ASSOCIATED OVER-VOLTAGE PROTECTION METHOD

(71) Applicant: Chengdu Monolithic Power Systems Co., Ltd., Chengdu (CN)

(72) Inventors: Qian Ouyang, Hangzhou (CN); Eric Yang, Saratoga, CA (US); Jinghai Zhou, San Jose, CA (US); Jijian Sun, Hangzhou (CN)

(73) Assignee: Chengdu Monolithic Power Systems Co., Ltd., Chengdu (CN)

(21) Appl. No.: 14/024,574

(22) Filed: Sep. 11, 2013

(30) Foreign Application Priority Data
Sep. 11, 2012 (CN) 201210333505.0

(51) Int. Cl. H02M 1/32

(52) U.S. Cl. CPC H02M 1/32
USPC 363/50

(57) ABSTRACT

A voltage converter includes: an input terminal receiving an input voltage; an output terminal providing an output voltage; a switching circuit having a main switch configured to regulate the output voltage, wherein a control end of the main switch is configured to receive a Pulse Width Modulation (PWM) signal, and the output voltage is controlled according to the duty cycle of the PWM signal; and a protection switch coupled between the input terminal and the switching circuit, and wherein when the output voltage is higher than a reference voltage, the protection switch is turned OFF.

### CROSS-REFERENCE TO RELATED APPLICATION(S)

This application claims the benefit of CN application No. 201210333505,0, filed on Sep. 11, 2012, and incorporated herein by reference.

### TECHNICAL HELD

The present invention generally relates to electrical circuit, more particularly but not exclusively relates to voltage converter and associated over-voltage protection method.

### BACKGROUND

FIG. 1 shows a prior art Direct Current to Direct Current (DC-DC) step-down converter or called Buck converter 100. Buck converter 100 comprises a high-side switch M1 and a low-side switch M2. The high-side switch M1 functions as a main switch for regulating an output voltage Vout at an output terminal of the voltage converter 100. The high-side switch M1 is coupled to an input terminal of the voltage converter 100 to receive an input voltage Vin. An output capacitor Cout is coupled between the output terminal and a reference ground GND. Generally, the output capacitor Cout works under a limited voltage level.

In some abnormal situations, for example, when the high-side switch M1 is electrically shorted, the output voltage Vout will increase in short time, and the output capacitor Cout will be broken and the load will no longer work normally or will be broken too.

In order to prevent the output voltage from increasing too high, a conventional over-voltage protection method couples a feedback signal FB indicating the output voltage to a control circuit 11. When the feedback signal FB increases to a threshold voltage, the control circuit 11 turns ON the low-side switch M2 for decreasing the output voltage Vout. However, in some situations, the over voltage situation happens because of load abnormity, and the control circuit 11 may not work normally. Accordingly, the low-side switch M2 may not be turned ON and the over-voltage protection may fail.

### SUMMARY

In order to address one or some of the above deficiencies, the present invention discloses one type of voltage converter and associated over-voltage protection method.

One embodiment of the present invention discloses a voltage converter, and the voltage converter has an input terminal configured to receive an input voltage and an output terminal configured to provide an output voltage for supplying a load. The voltage converter further comprises a switching circuit, having an input and an output, wherein the output of the switching circuit is coupled to the output terminal of the voltage converter, the switching circuit comprising a main switch configured to regulate the output voltage, wherein a control end of the main switch is configured to receive a Pulse Width Modulation (PWM) signal, and the output voltage is controlled according to the duty cycle of the PWM signal; and a protection switch having a first end, a second end and a control end, wherein the first end is coupled to the input terminal, the second end is coupled to the input of the switching circuit, and wherein when the output voltage is higher than a reference voltage, the protection switch is turned OFF via the voltage at the control end of the protection switch.

Another embodiment of the present invention discloses an over-voltage protection circuit used in a voltage converter. The over-voltage protection circuit comprises: a switch having a first end, a second end and a control end, wherein the first end is coupled to an input terminal of the voltage converter, the second end is coupled to a switching circuit of the voltage converter; and a comparing circuit having a first input, a second input and an output, wherein the first input of the comparing circuit is coupled to an output terminal of the voltage converter, the second input of the comparing circuit is coupled to a threshold signal and the output of the comparing circuit is coupled to the control end of the switch.

Yet another embodiment of the present invention discloses an over-voltage protection method in a voltage converter. The method comprises: coupling a switch between an input terminal of the voltage converter and a switching circuit of the voltage converter; sensing the output voltage of the voltage converter; comparing the output voltage to a reference voltage; and turning OFF the switch when the output voltage is higher than the reference voltage.

### BRIEF DESCRIPTION OF THE DRAWINGS

Non-limiting and non-exhaustive embodiments are described with reference to the following drawings. The drawings are only for illustration purpose. Usually, the drawings only show part of the system or circuit of the embodiments.

FIG. 1 shows a prior art DC-DC step-down converter.

FIG. 2 illustrates a voltage converter comprising a protection switch at an input stage according to an embodiment of the present invention.

FIG. 3 shows a voltage converter comprising a protection capacitor according to an embodiment of the present invention.

FIG. 4 shows a voltage converter comprising a protection control circuit according to an embodiment of the present invention.

FIG. 5 shows a voltage converter comprising a boost converter according to an embodiment of the present invention.

FIG. 6 shows a voltage converter wherein the protection switch comprises a MOSFET according to an embodiment of the present invention.

FIG. 7 illustrates a method of over-voltage protection in a voltage converter according to an embodiment of the present invention.

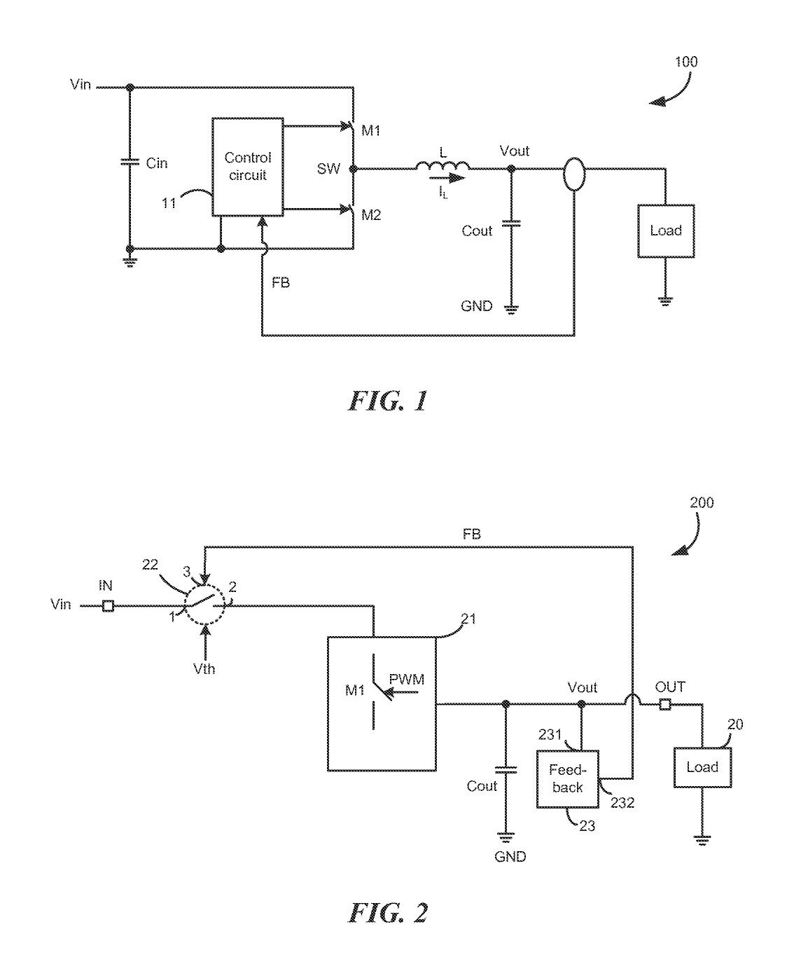

The use of the same reference label in different drawings indicates the same or like components.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

The term “couple” refers to direct connection or indirect connection through intermediate such as electrical conductor, diodes, resistors, capacitors, and/or other intermediaries.

A “voltage converter” is a circuit/apparatus or system that converts an input voltage of a first voltage into an output voltage of a second voltage. In one embodiment, the first voltage or the second voltage each is at a predetermined value or in a predetermined range. However, the first voltage or the second voltage each may have any substantially constant value or variable value.

FIG. 2 illustrates a voltage converter 200 comprising a protection switch 22 at input stage according to an embodiment of the present invention. Voltage converter 200 comprises an input terminal IN, an output terminal OUT, a switching circuit 21, a protection switch 22 and a feedback circuit 23. The input terminal IN receives an input voltage Vin. The output terminal OUT provides an output voltage Vout to a load 20. Feedback circuit 23 having an input 231 and an output 232 wherein input 231 is coupled to the output terminal OUT to receive the output voltage Vout, and output 232 provides a feedback signal FB which indicates the output voltage Vout. Feedback signal FB may be a voltage signal, a current signal or any other type of signal. Switching circuit 21 comprises a main switch M1 for regulating the output voltage Vout. The control end of the main switch M1 receives a PWM signal, and the output voltage Vout is regulated by the duty cycle of the PWM signal. In one embodiment, the switching circuit 21 of voltage converter 200 comprises a Buck converter and converts an input voltage into an output voltage which is smaller than the input voltage, wherein the main switch is a high-side switch and the output voltage is proportional to the duty cycle of the PWM signal that is coupled to the control end of the high-side switch. In another embodiment, the voltage converter comprises a DC-DC step-up converter or called boost converter. In yet another embodiment, the voltage converter comprises an isolated DC-DC voltage converter.

Continuing with FIG. 2, protection switch 22 has a first end 1, a second end 2 and a control end 3. The first end 1 is coupled to the input terminal IN, and the second end 2 is coupled to switching circuit 21. When the voltage at the output terminal OUT is too high and feedback signal FB is higher than a threshold voltage Vth, protection switch 22 is turned OFF to disconnect switching circuit 21 from the input terminal IN. Thus, when main switch M1 is electrically shorted, it is prevented that the output terminal OUT is coupled to the input terminal IN directly for a relatively long time period. In one embodiment, feedback signal FB is proportional to the output voltage Vout, and threshold signal Vth is also a voltage signal. In another embodiment, feedback signal and threshold signal are both current signal. In the shown embodiment, voltage converter 200 further comprises an output capacitor Gout for smoothing the output voltage Vout at the output terminal OUT. In one embodiment, the output capacitor can also be deemed as part of the switching circuit 21.

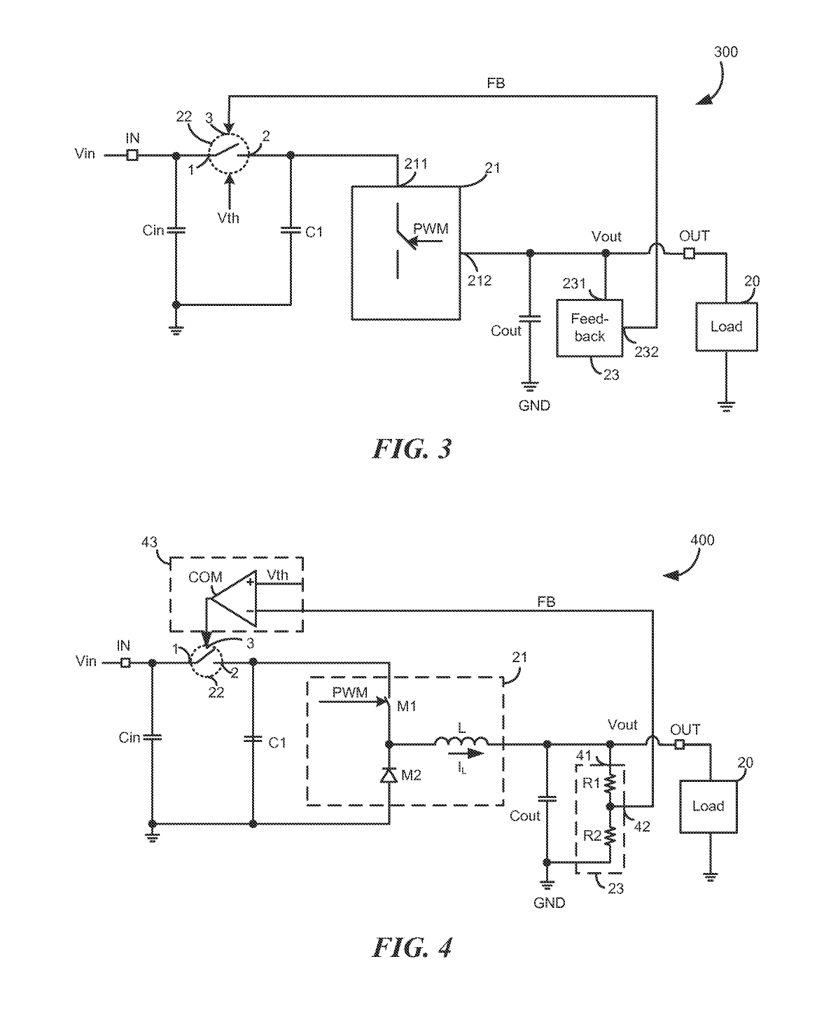

FIG. 3 shows a voltage converter 300 comprising a protection capacitor C1 according to an embodiment of the present invention. Compared to voltage converter 200, voltage converter 300 further comprises an input capacitor Cin and a protection capacitor C1. The input capacitor Cin is coupled between the input terminal IN and reference ground GND. And the protection capacitor C1 is coupled between the second end 2 of protection switch 22 and reference ground GND. Protection capacitor C1 prevents an abrupt voltage change at the second end 2 of protection switch 22 and smoothes the voltage supplied into an input 211 of switching circuit 21. In another embodiment, protection capacitor C1 is coupled between the input 211 and the output 212 of the switching circuit 21.

FIG. 4 shows a voltage converter 400 comprising a protection control circuit 43 according to an embodiment of the present invention. Switching circuit of voltage converter 400 comprises a Buck converter 21. Buck converter 21 comprises a high-side switch M1 functioning as a main switch, a low-side switch M2 functioning as a rectifier and an inductor L. A first end of the high-side switch M1 is coupled to the second end 2 of the protection switch 22. A second end of the high-side switch M1 is coupled to a first end of the rectifier M2 and a first end of the inductor L. The second end of the rectifier M2 is coupled to a reference ground GND. A second end of the inductor L is coupled to the output terminal OUT. And the control end of the high-side switch M1 receives a PWM signal. The high-side switch M1 and the low-side switch M2 are turned ON and OFF in complementary pattern so as to provide a square waveform at a switching node SW between the high-side switch M1 and the low-side switch M2. Inductor L and the output capacitor Cout filter the square waveform at node SW and provide the DC output voltage Vout at the output terminal OUT, wherein the output voltage Vout is lower than the input voltage Vin. The output voltage Vout equals the product of the input voltage Vin multiplying the duty cycle of the PWM signal which is supplied to the control end of the high-side switch M1. In the shown embodiment, the low-side switch M2 comprises a non-synchronous rectifier of diode. In another embodiment, the low-side switch comprises a synchronous rectifier, for example, a Metal Oxide Semiconductor Field Effect Transistor (MOSFET). In one embodiment, the Buck converter 21 comprises the output capacitor Cout. In one embodiment, an over-voltage protection circuit comprises protection switch 22 and protection control circuit 43.

In the embodiment shown in FIG. 4, the protection control circuit 43 comprises a comparing circuit COM. The comparing circuit COM has a first input, e.g. inverting input coupled to the output 42 of feedback circuit 23, a second input, e.g. non-inverting input coupled to a threshold signal Vth, and an output coupled to control end 3 of protection switch 22. When the feedback signal FB surpasses the threshold signal Vth, the comparing circuit COM outputs logic low signal and turns OFF the protection switch 22 via control end 3. Protection control circuit 43 may further comprise other components or circuits, for example, a threshold signal generating circuit for generating the threshold signal Vth, and/or driving circuit coupled between the output of comparing circuit COM and control end 3 of protection switch 22. It is noted that protection control circuit 43 may be used in any type of voltage converter, for example, a boost converter. In one embodiment, comparing circuit COM comprises a comparator. And the comparing circuit may comprise any other type of circuit or apparatus that can turn OFF a switch (such as switch 22) when a signal (such as signal FB) is higher than a threshold signal (such as signal Vth).

In one embodiment, feedback circuit 23 comprises a first resistor R1 and a second resistor R2. The first resistor R1 has a first end coupled to the output terminal OUT of voltage converter 400 and a second end coupled to output 42 of feedback circuit 23. The second resistor R2 has a first end coupled to output 42 of feedback circuit 23, and a second end coupled to reference ground CND. The feedback circuit may comprise any other suitable voltage sensing circuit or voltage sensing apparatus, for example, an RC voltage sensing circuit. In one embodiment, the feedback circuit comprises a conductor coupled between the protection control circuit and the output terminal.

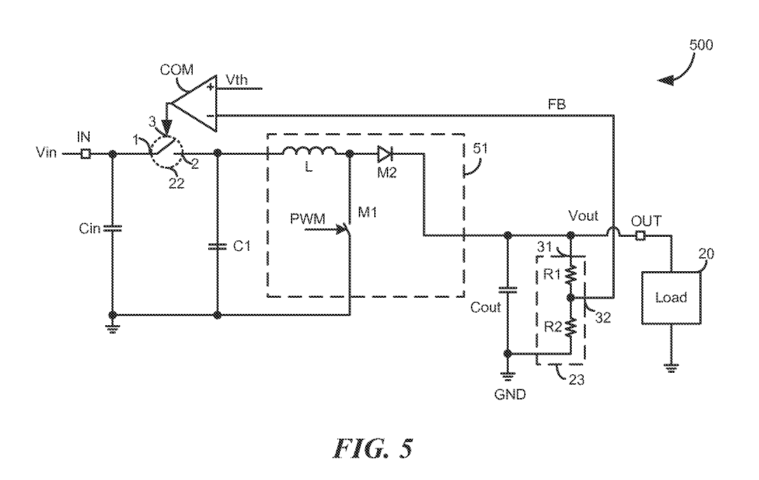

FIG. 5 shows a voltage converter 500 comprising a boost converter according to an embodiment of the present invention. Wherein, the switching circuit of voltage converter 500 comprises a boost converter 51. In this embodiment, the protection switch 22 is coupled between the input terminal IN and the switching circuit 51, and to be more particular, coupled between the input terminal IN and the inductor L of the boost converter 51.

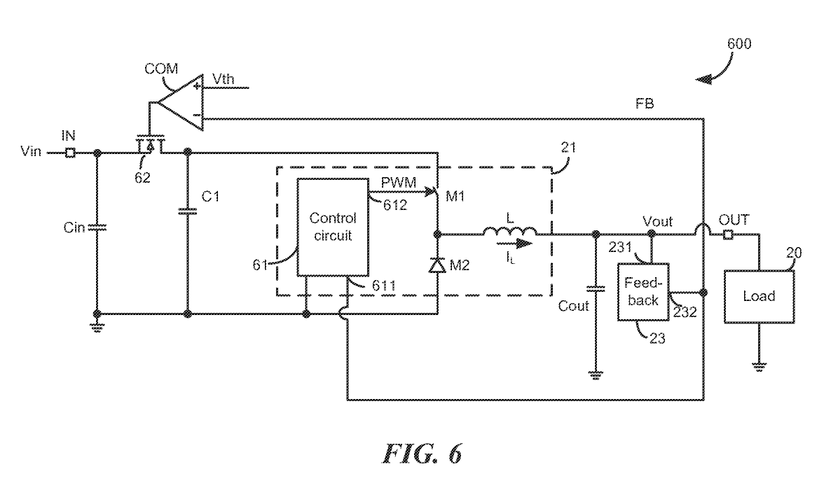

FIG. 6 shows a voltage converter 600 according to an embodiment of the present invention, Switching circuit 21 of voltage converter 600 comprises a Buck converter an, a protection switch 62 of voltage converter 600 comprises a MOSFET. In one embodiment, the source of the MOSFET is coupled to the input terminal IN, the drain of the MOSFET is coupled to the high-side switch M1 of switching circuit 21, and the gate of the MOSFET is coupled to the output of comparing circuit COM of protection control circuit. In another embodiment, the protection switch at input stage may be in any other type, for example, a Junction Field Effect Transistor (JFET).

Compared to voltage converter 500 in FIG. 5, voltage converter 600 further comprises a control circuit 61 for generating the PWM signal, Control circuit 61 has an input 611 and an output 612. The input 611 receives feedback signal FB, and the output 612 provides the PWM signal. The PWM signal is generated at least based on feedback signal FB, and the duty cycle of the PWM signal is modulated at least according to the feedback signal FB. Control circuit 61 may further receive other signals such as output current signal for regulating the PWM signal. Control circuit 61 may further generates another signal to control a synchronous rectifier of the switching circuit. The control circuit may be in any conventional type used in a DC-DC voltage converter such as a constant on time control circuit.

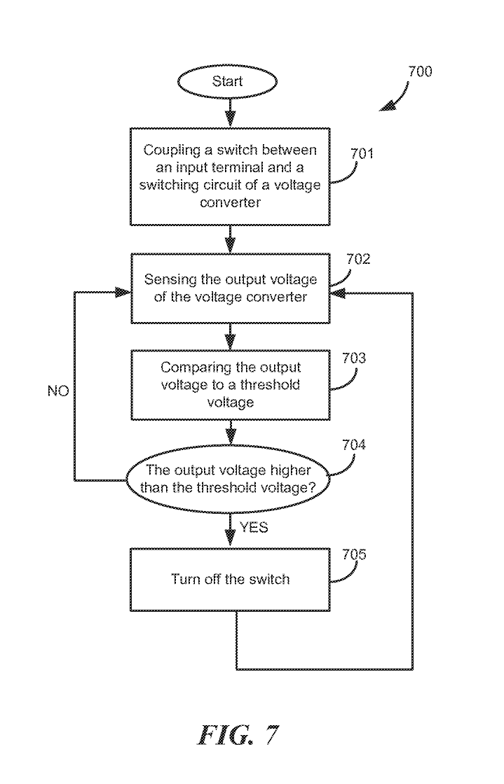

FIG. 7 illustrates a method of over-voltage protection in a voltage converter according to an embodiment of the present invention. The method 700 comprises in a first step 701 coupling a protection switch between an input terminal of the voltage converter and a switching circuit of the voltage converter. At the initial time, the protection switch is in ON state. In one embodiment, the switching circuit comprises a Buck converter. The protection switch is coupled between the input terminal of the voltage converter and the high-side switch of the Buck converter. In another embodiment, the switching circuit comprises a Boost converter, and the protection switch is coupled between the input terminal of the voltage converter and the inductor of the boost converter. The protection method 700 comprises in a second step 702 sensing the output voltage of the voltage converter. In one embodiment, sensing the output voltage of the voltage converter is performed by a voltage divider, for example the voltage divider of feedback circuit 23 shown in FIG. 4, and obtaining the feedback signal of the output voltage via the feedback circuit. The method 700 comprises in a third step 703 comparing the output voltage with a threshold voltage, for example, comparing the feedback signal FB with the threshold signal Vth as shown in FIG. 3. The over-voltage protection method 700 comprises in a fourth step 704 judging whether the output voltage is higher than the threshold voltage. If the output voltage is higher than the threshold voltage, turn off the protection switch in step 705. And if the output voltage is not higher than the threshold voltage, turns to step 702 and continues to sense the output voltage.

In one embodiment, the method 700 further comprises coupling a protection capacitor between the near-output end of the protection switch and the reference ground, where the near-output end of the protection switch is the end among two ends of the protection switch which is nearer to the output terminal, for example the end 2 of the protection switch 22 in FIG. 2. When the voltage converter comprises a Buck converter, the near-output end of the protection switch is the end which couples to the high-side switch. And when the voltage converter comprises a Boost converter, the near-output end of the protection switch is the end which couples to the inductor. The protection capacitor is configured to prevent the abrupt voltage change at the near-output end of the protection switch so as to make the system stable.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

I/we claim:

1. A voltage converter having an input terminal configured to receive an input voltage and an output terminal configured to provide an output voltage for supplying a load, the voltage converter comprising:
a switching circuit, having an input and an output, wherein the output of the switching circuit is coupled to the output terminal of the voltage converter, the switching circuit comprising a main switch configured to regulate the output voltage, wherein a control end of the main switch is configured to receive a Pulse Width Modulation (PWM) signal, and further wherein the output voltage is controlled according to the duty cycle of the PWM signal; and
a protection switch having a first end, a second end and a control end, wherein the first end is coupled to the input terminal of the voltage converter, the second end is coupled to the input of the switching circuit, and wherein when the output voltage is higher than a reference voltage, the protection switch is turned OFF by the voltage at the control end of the protection switch.

2. The voltage converter of claim 1, further comprising a feedback circuit, the feedback circuit having an input and an output, wherein the input of the feedback circuit is coupled to the output terminal of the voltage converter and the output of the feedback circuit is configured to provide a feedback signal indicating the output voltage, and wherein when the feedback signal is higher than a threshold signal, the protection switch is turned OFF.

3. The voltage converter of claim 2, further comprising a comparing circuit, the comparing circuit having a first input, a second input and an output, wherein the first input is coupled to the output of the feedback circuit, the second input is configured to receive the threshold signal, and the output of the comparing circuit is coupled to the control end of the protection switch.

4. The voltage converter of claim 2, wherein the feedback circuit comprises:
a first resistor having a first end and a second end, wherein the first end of the first resistor is coupled to the output terminal of the voltage converter, and the second end of the first resistor is coupled to the output of the feedback circuit:
a second resistor r having a first end and a second end, wherein the first end of the second resistor is coupled to the output of the feedback circuit, and the second end of the second resistor is coupled to a reference ground.

5. The voltage converter of claim 1, further comprising a protection capacitor coupled between the second end of the protection switch and a reference ground.

6. The voltage converter of claim 1, further comprising a protection capacitor coupled between the input of the switching circuit and the output of the switching circuit.

7. The voltage converter of claim 1, wherein the switching circuit comprises a Buck converter, and wherein the main switch comprises a high-side switch, and further wherein the second end of the protection switch is coupled to the high-side switch.

8. The voltage converter of claim 7, wherein the Buck converter comprises a non-synchronous rectifier.

9. The voltage converter of claim 1, wherein the switching circuit comprises a Boost converter, and wherein the second end of the protection switch is coupled to an inductor of the Boost converter.

10. The voltage converter of claim 1, wherein the protection switch comprises a Metal Oxide Semiconductor Field Effect Transistor (MOSFET).

11. The voltage converter of claim 10, wherein the voltage converter comprises a Buck converter, the Buck converter having a high-side switch, and wherein a source of the MOSFET is coupled to the input terminal of the voltage converter, a drain of the MOSFET is coupled to the high-side switch, and a gate of the MOSFET is coupled to an output of a comparing circuit, and further wherein the comparing circuit is configure to compare the output voltage with a reference voltage.

12. The voltage converter of claim 1, further comprising a control circuit, the control circuit having an input and an output, wherein the input of the control circuit is configured to receive the feedback signal, and the output of the control circuit is configured to provide the PWM signal based on the feedback signal.

13. An over-voltage protection circuit used in a voltage converter, comprising:
a switch having a first end, a second end and a control end, wherein the first end is coupled to an input terminal of the voltage converter, the second end is coupled to a switching circuit of the voltage converter; and
a comparing circuit having a first input, a second input and an output, wherein the first input of the comparing circuit is coupled to an output terminal of the voltage converter, the second input of the comparing circuit is coupled to a threshold signal and the output of the comparing circuit is coupled to the control end of the switch.

14. The over-voltage protection circuit of claim 13, further comprising a capacitor coupled between the second end of the switch and a reference ground.

15. An over-voltage protection method in a voltage converter, comprising:
coupling a switch between an input terminal of the voltage converter and a switching circuit of the voltage converter;
sensing the output voltage of the voltage converter;
comparing the output voltage to a reference voltage; and
turning OFF the switch when the output voltage is higher than the reference voltage.

16. The method of claim 15, further comprising coupling a capacitor between a near-output end of the switch and a reference ground.

17. The method of claim 15, further comprising coupling a capacitor between an input of the switching circuit and an output of the switching circuit.
